(19) United States
(12) Patent Application Publication
(10) Pub. No.: US 2024/0059942 A1
(43) Pub. Date: Feb. 22, 2024

(54) PRESSURE SENSITIVE ADHESIVES FOR HIGH TEMPERATURE APPLICATIONS

(71) Applicant: Arkema France, Colombes (FR)

(72) Inventors: Jon SCHOLTE, Exton, PA (US); Jeffrey KLANG, Exton, PA (US)

(21) Appl. No.: 18/267,487

(22) PCT Filed: Dec. 15, 2021
(86) PCT No.: PCT/EP2021/085876

§ 371 Date: Jun. 15, 2023

(30) Foreign Application Priority Data
Dec. 16, 2020 (FR) FR2013347

(51) Int. Cl. C09J 151/08

(52) U.S. Cl. CPC C09J 151/08

(57) ABSTRACT

Pressure sensitive adhesives having high shear failure temperatures are made by reacting a curable pressure sensitive adhesive composition comprising: a. a pre-polymer having a structure according to Formula (I) R₁—[Polymer]—R₂. wherein the [Polymer] is a linear or branched polymer backbone derived from the reaction of farnesene and at least one other monomer: and R₁ is a (C₁-C₁₂) alkyl group or R₂. and R₂ comprises a (meth)acrylate group having a structure according to Formula (II), wherein Z is selected from the group consisting of hydrogen and methyl: b. at least one functional (meth)acry late monomer: and c. at least one photo-initiator.

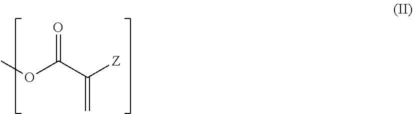

### BACKGROUND

This invention relates to adhesive compositions, and more particularly to pressure sensitive adhesive compositions that perform well at high temperatures, including 204° C. and above before shear failure.

Pressure sensitive adhesives (PSAs) are a unique class of materials which must simultaneously be capable of flowing to wet a surface while also capable of resisting flow in order to remain in place. PSAs are generally based on a polymer, a tackifier, and an oil. Some common PSAs are based on polymers such as natural rubbers, synthetic rubbers (e.g., styrene-butadiene rubber and styrene-isoprene-styrene copolymer), polyacrylates, polymethacrylates, and poly-alphaolefins.

PSAs have been used in a variety of applications, as they provide many desirable characteristics such as removability and ease of application. For a more permanent bond, some conventional PSAs may not necessarily have sufficient strength to hold and maintain its adherence on certain substrates. Furthermore, conventional PSAs when applied to certain materials, may not be able to withstand exposure to elevated temperatures or high humidity.

Radiation curing has been used frequently to chemically crosslink the polymeric component of adhesives in attempts to increase the cohesive strength of coated adhesive films. Indeed, one of the largest benefits of UV and electron beam (EB) curable coatings and adhesives is the ability to include a crosslinking molecule. Such inclusions change the rheology (i.e., how the polymer flows) drastically by essentially making the entire adhesive one molecule. As a result of this crosslinking, the material is often no longer an adhesive, exhibiting low peel and shear values as well as almost no observable tack. Indeed, in some PSA systems, especially those formulated from polymers containing propylene, radiation curing leads to a loss of cohesive strength and shear adhesion.

What is desired is an adhesive that can be used in high temperature applications while maintaining its integrity, as well as ease of application for efficient manufacturing.

### BRIEF SUMMARY

Disclosed herein is a curable pressure sensitive adhesive composition, the curable composition comprising, consisting essentially of, or consisting of: a. a pre-polymer having a structure according to Formula I

[Chem 1]

R₁—[Polymer]—R₂ Formula I,

wherein the [Polymer] is a linear or branched polymer backbone derived from the reaction of farnesene and at least one other monomer; and R₁ is a (C1-C12) alkyl group or R₂, and R₂ comprises a (meth)acrylate group having a structure according to Formula II

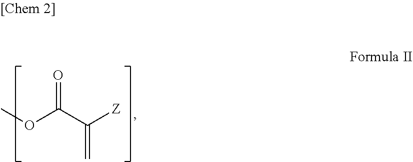

wherein Z is selected from the group consisting of hydrogen and methyl; b. at least one functional (meth)acrylate monomer; and c. at least one photo-initiator.

In another aspect there is provided a pressure sensitive adhesive comprising a polymeric reaction product of a curable pressure sensitive adhesive composition comprising:

a. a pre-polymer having a structure according to Formula I

[Chem 3]

R₁—[Polymer]—R₂ Formula I,

wherein the [Polymer] is a linear or branched polymer backbone derived from the reaction of farnesene and at least one other monomer; and R₁ is a (C₁-C₁₂) alkyl group or R₂, and R₂ comprises a (meth)acrylate group having a structure according to Formula II

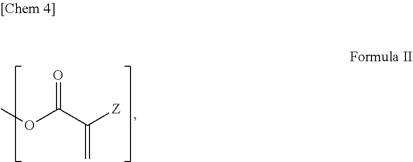

wherein Z is selected from the group consisting of hydrogen and methyl; b. at least one functional (meth)acrylate monomer; and c. at least one photo-initiator, wherein the pressure sensitive adhesive has a shear failure temperature greater than about 204° C.

In another aspect there is provided a method of applying a pressure sensitive

adhesive to a substrate, the method comprises the steps of: (i) applying a curable pressure sensitive adhesive composition to a substrate, the curable composition comprising a. a pre-polymer having a structure according to Formula I

[Chem 5]

R₁—[Polymer]—R₂ Formula I,

wherein the [Polymer] is a linear or branched polymer backbone derived from the reaction of farnesene and at least one other monomer; and R₁ is a (C₁-C₁₂) alkyl group or R₂, and R₂ comprises a (meth)acrylate group having a structure according to Formula II

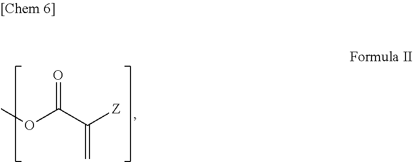

wherein Z is selected from the group consisting of hydrogen and methyl; b. at least one functional (meth)acrylate monomer; and c. at least one photo-initiator; and (ii) exposing the curable composition to actinic radiation to polymerize at least a portion of the composition to generate the pressure sensitive adhesive.

### DETAILED DESCRIPTION

Embodiments described herein can be understood more readily by reference to the following detailed description and examples. Elements and methods described herein, however, are not limited to the specific embodiments presented in the detailed description and examples. It should be recognized that these embodiments are merely illustrative of the principles of the present disclosure. Numerous modifications and adaptations will be readily apparent to those of ordinary skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “from 5 to 10” or “5-10” should generally be considered to include the end points 5 and 10.

When the phrase “up to” is used in connection with an amount or quantity, it is to be understood that the amount is at least a detectable amount or quantity. For example, a material present in an amount “up to” a specified amount can be present from a detectable amount and up to and including the specified amount.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A). In another embodiment, to at least one, optionally including more than one, A, and at least one, optionally including more than one, B (and optionally including other elements), etc.

As used herein, “(meth)acrylate” is inclusive of both acrylate and methacrylate functionality.

The terms “functional (meth)acrylate monomer” means a monomer comprising at least one (meth)acrylate functional group.

The terms “mono-, di- or tri-functional (meth)acrylate” means a compound having 1, 2 or 3 (meth)acrylate functional groups.

The term “(meth)acrylate functional group” means a group of formula —O—C(═O)—CR═CH₂, wherein R is H or methyl.

The term «aliphatic compound/group» means an optionally substituted non-aromatic compound/group. It may be linear or branched, saturated or unsaturated. It may comprise one or more heteroatoms, such as O, N, or S, as ring atoms.

The term «acyclic compound/group» means an optionally substituted compound/group that does not comprise any rings.

The term «cyclic compound/group» means an optionally substituted compound/group that comprises one or more rings.

The term «cycloaliphatic compound/group» means an optionally substituted non-aromatic cyclic compound/group. It may comprise one or more heteroatoms, such as O, N, or S, as ring atoms.

The term «aromatic compound/group» means an optionally substituted compound/group comprising an aromatic ring, which means that respects Hückel's aromaticity rule, in particular an optionally substituted compound/group comprising a phenyl group.

The term «optionally substituted compound/group» means a compound/group substituted by one or more groups selected from alkyl, cycloalkyl, aryl, heteroaryl, alkoxy, alkylaryl, haloalkyl, hydroxy, halogen, isocyanate, nitrile, amine, carboxylic acid, —C(═O)—R′—C(═O)—OR′, —C(═O)NH—R′, —NH—C(═O)R′, —O—C(═O)—NH—R′, —NH—C(═O)—O—R′, —C(═O)—O—C(═O)—R′ and —SO₂—NH—R′, each R′ being independently an optionally substituted group selected from alkyl, aryl and alkylaryl.

As used herein, the term “alkoxylated” refers to compounds in which one or more epoxides such as ethylene oxide and/or propylene oxide have been reacted with active hydrogen-containing groups (e.g., hydroxy groups) of a base compound, such as a polyol, to form one or more oxyalkylene moieties. For example, from 1 to 25 moles of epoxide may be reacted per mole of base compound.

The term «cycloalkyl» means a non-aromatic cyclic hydrocarbon group. A cycloalkyl may comprise one or more carbon-carbon double bonds. A «C3-C8 cycloalkyl» means a cycloalkyl having 3 to 8 carbon atoms. Examples of cycloalkyl groups include cyclopentyl, cyclohexyl and isobornyl.

The term «heterocycloalkyl» means a cycloalkyl having at least one ring atom that is a heteroatom selected from O, N, or S.

The term «aryl» means an aromatic hydrocarbon group. A «C6-C12 aryl» means

an aryl having 6 to 12 carbon atoms.

The term «heteroaryl» means an aryl having at least one ring atom that is a heteroatom such as O, N, S and mixtures thereof. A «C5-C9 heteroaryl» means a heteroaryl having 5 to 9 carbon atoms.

Curable pressure sensitive adhesive composition

In embodiments, a curable pressure sensitive adhesive composition is provided that includes a farnesene-based pre-polymer (oligomer) and a (meth)acrylate, and an initiator, such as a photo-initiator. The components, when blended, provide an adhesive that can be applied as a pressure sensitive film or tape. Upon exposure to actinic radiation, the applied blend can then cure to harden to provide a secure, structural bond for use in high temperature applications, i.e., up to about 260° C.

In embodiments disclosed herein, there is provided a curable pressure sensitive adhesive composition, the curable composition comprises, consists essentially of, or consists of: a. a pre-polymer having a structure according to Formula I

[Chem 7]

R₁—[Polymer]—R₂ Formula I,

wherein the [Polymer] is a linear or branched polymer backbone derived from the reaction of farnesene and at least one other monomer; and R₁ is a (C₁-C₁₂) alkyl group or R₂, and R₂ comprises a (meth)acrylate group having a structure according to Formula II

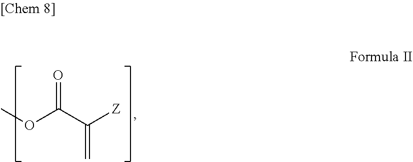

wherein Z is selected from the group consisting of hydrogen and methyl; and b. at least one functional (meth)acrylate monomer. Upon exposure to electron beam or actinic radiation, the applied mixture, which may comprise additional components as described below, will form a polymer suitable for use as a pressure sensitive adhesive for use in high temperature applications, i.e., up to about 260° C.

The [Polymer] component of the pre-polymer having the structure of Formula I is a linear or branched polymer backbone derived from the anionic reaction of farnesene and at least one other monomer. Preferably, the farnesene is (E)-β-farnesene (7,11-dimethyl-3-methylene-1,6,10-dodecatriene) having the following structure:

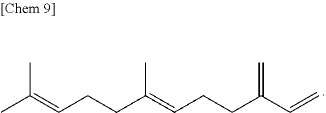

The above structure also includes embodiments in which one or more hydrogen atoms have been replaced by another atom or group of atoms (i.e., substituted). In some embodiments, the [Polymer] component is derived from β-farnesene with a given amount of 3,4 vs 1,4 addition.

The farnesene component of the [Polymer] preferably has a degree of saturation greater than 50%. In some embodiments, the degree of saturation is greater than about 55%, greater than about 60%, greater than about 65%, greater than about 70%, greater than about 75%, greater than about 80%, greater than about 85%, greater than about 90%, or greater than about 95%. In one embodiment, the farnesene component of the [Polymer] is completely hydrogenated (i.e., 100% saturation). The degree of saturation is determined by analytical methods known in the art, such as iodine value.

As noted above, the [Polymer] component of the pre-polymer of Formula I is derived from the reaction of β-farnesene and at least one other monomer. In particular, the [Polymer] component may be derived from the reaction of β-farnesene and at least one other monomer selected from a diene, an oxygen source, a diisocyanate and mixtures thereof.

The [Polymer] component of the pre-polymer of Formula I may be derived from the reaction of β-farnesene with a diene. Examples of suitable dienes include butadiene, isoprene, myrcene and mixtures thereof.

The [Polymer] component of the pre-polymer of Formula I may be derived from the reaction of β-farnesene with an oxygen source. The oxygen source may be selected from an alkylene oxide and a peroxide, preferably an alkylene oxide. Examples of suitable alkylene oxides include ethylene oxide, propylene oxide and mixtures thereof.

The [Polymer] component of the pre-polymer of Formula I may be derived from the reaction of β-farnesene with a diisocyanate. Examples of suitable diisocyanates include, but are not limited to, aromatic diisocyanates (e.g., 2,6-tolyene diisocyanate; 2,5-tolyene diisocyanate; 2,4-tolyene diisocyanate; m-phenylene diisocyanate; 5-chloro-2,4-tolyene diisocyanate; and 1-chloromethyl-2,4-diisocyanato benzene), aromatic-aliphatic diisocyanates (e.g., m-xylylene diisocyanate and tetramethyl-m-xylylene diisocyanate), aliphatic diisocyanates (e.g., 1,4-diisocyanatobutane; 1,6-diisocyanatohexane; 1,12-diisocyanatododecane; and 2-methyl-1,5-diisocyanatopentane), and cycloaliphatic diisocyanates (e.g., methylenedicyclohexylene-4,4′-diisocyanate; 3-isocyanatomethyl-3,5,5-trimethylcyclohexyl isocyanate (isophorone diisocyanate)); 2,2,4-trimethylhexyl diisocyanate; and cyclohexylene-1,4-diisocyanate), and other compounds terminated by two isocyanate-functional groups (e.g., the diurethane of tolyene-2,4-diisocyanate-terminated polypropylene oxide polyol).

Preferred diisocyanates include, for example, hexamethylene diisocyanate (HDI), isophorone diisocyanate (IPDI), toluene diisocyanate (TDI), and diphenylmethane diisocyanate (MDI).

The type of diisocyanate employed may affect the properties of the PSA. For example, when a symmetrical diisocyanate is used, an increase in shear strength may be observed, as compared to using the same amount of an asymmetrical diisocyanate.

Preferably, the [Polymer] component of the pre-polymer of Formula I is derived from the reaction of β-farnesene, an oxygen source, a diisocyanate and optionally a diene.

The [Polymer] component of the pre-polymer of Formula I may correspond to one of the following formulae:

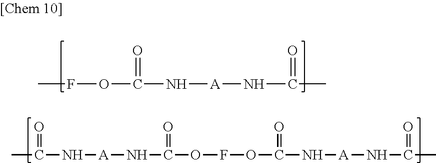

wherein
A is the residue of a diisocyanate without the NCO groups;
F is a polymeric moiety comprising repeating units obtained by the polymerization of farnesene and optionally a diene.

In Formula I, R₁ is a (C₁-C₁₂) alkyl group or R₂, and R₂ comprises a (meth)acrylate group having a structure according to Formula II:

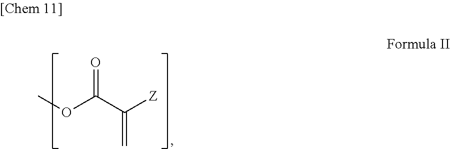

wherein Z is selected from the group consisting of hydrogen and methyl.

In particular, R₂ may be a group of formula III:

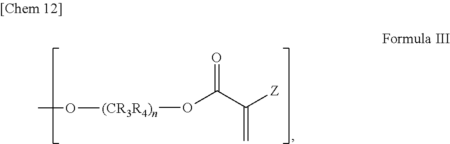

wherein Z is selected from the group consisting of hydrogen and methyl;
R₃ and R₄ are independently selected from the group consisting of hydrogen and methyl;
n is 2 to 10.

Alternatively, R₂ may be a group of formula IV:

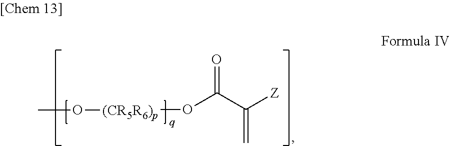

wherein Z is selected from the group consisting of hydrogen and methyl;
R₅ and R₆ are independently selected from the group consisting of hydrogen and methyl;
p is 2 to 4, in particular 2;
q is 2 to 30.

R₂ may be the residue of a hydroxy-functional (meth)acrylate without the hydrogen of the OH group. In particular, R₂ may be the residue of hydroxy-functional (meth)acrylate selected from the group consisting of 2-hydroxyethyl (meth)acrylate, 2-hydroxypropyl (meth)acrylate, 4-hydroxybutyl (meth)acrylate, and polyethylene glycol (meth)acrylate.

In one embodiment, the pre-polymer of Formula I may correspond to the following formula V:

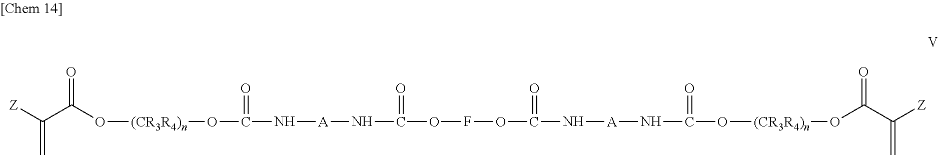

wherein
A is the residue of a diisocyanate without the NCO groups, preferably the residue of isophorone diisocyanate;
F is a polymeric moiety comprising repeating units obtained by the polymerization of farnesene and optionally a diene;
Z is selected from the group consisting of hydrogen and methyl, preferably H;
R₃ and R₄ are independently selected from the group consisting of hydrogen and methyl, preferably H;
n is 2 to 10, preferably 2.

The pre-polymer of Formula I component may have a number average molecular weight less than or equal to 100,000 g/mol, preferably less than or equal to 25,000 g/mol. As used herein, whenever number average molecular weight is referred to herein, the number average molecular weight is determined by gel permeation chromatography, using polystyrene standards and THE as the mobile phase. The pre-polymer of Formula I component prior to curing may have a viscosity less than or equal to 100,000 mPa·s, more preferably less than 50,000 mPa·s, and most preferably less than or equal to 25,000 mPa·s, wherein viscosity is measured at 60° C.

The pre-polymer of Formula I component and its synthesis is generally disclosed in U.S. patent application Publication No. US 2016/0376386 A1, which is incorporated herein by reference in its entirety.

In particular, the pre-polymer of Formula I may be obtained by the following process:
a) anionically polymerizing monomers to provide a polymer having at least one living end, the monomers comprising farnesene and optionally a diene;
b) quenching the at least one living end with an oxygen source to provide a hydroxyl-terminated polymer;
c) optionally hydrogenating the hydroxyl-terminated polymer to provide an at least partially saturated hydroxyl-terminated polymer;
d) reacting the optionally partially saturated hydroxyl-terminated polymer with a diisocyanate to provide an isocyanate-terminated polymer
e) reacting the isocyanate-terminated polymer with a hydroxy-functional (meth)acrylate to provide a (meth)acrylate-terminated polymer.

The pre-polymer of Formula I component may be present in the curable composition disclosed herein at from about 10 to about 90 wt. %, preferably from about 20 to about 80 wt. %, and most preferably from about 25 to about 70 wt. %, based on the weight of the curable composition. The total amount of pre-polymer of Formula I in the curable pressure sensitive adhesive composition may be from 10 to 70%, from 15 to 65%, from 20 to 60% or from 25 to 55%, by weight based on the weight of the curable composition.

The curable pressure sensitive adhesive composition as disclosed herein further comprises at least one functional (meth)acrylate monomer. The at least one functional (meth)acrylate may be a monofunctional (meth)acrylate, a difunctional (meth)acrylate, or a trifunctional (meth)acrylate. Monofunctional (meth)acrylate monomers are preferred over difunctional (meth)acrylates which, in turn, are preferred over trifunctional (meth)acrylates (i.e., monofunctional>difunctional>trifunctional).

Suitable, illustrative monofunctional (meth)acrylates include 2-phenoxyethylacrylate, alkoxylated lauryl acrylate, alkoxylated phenol acrylate, alkoxylated tetrahydrofurfuryl acrylate, caprolactone acrylate, cyclic trimethylolpropane formal acrylate, ethylene glycol methyl ether methacrylate, ethoxylated nonyl phenol acrylate, isobornyl acrylate (e.g., SR506 from Sartomer Chemical Corp.), isobornyl methacrylate (e.g., SR 423 from Sartomer Chemical Corp.), isodecyl acrylate, 2-ethylhexyl acrylate, isooctyl acrylate, lauryl acrylate, octadecyl acrylate (stearyl acrylate), tetrahydrofurfuryl acrylate (e.g., SR285 from Sartomer), tridecyl acrylate, and 4-acryolyl morpholine (from Sigma-Aldrich). Monofunctional urethane (meth)acrylates such as 2-[[(butylamino)carbonyl]oxy]ethyl acrylate, available from IGM Resins under the product name Photomer® 4184 may be used.

Suitable, illustrative difunctional (meth)acrylates include 1,12-dodecane diol diacrylate, 1,3-butylene glycol diacrylate, 1,4-butanediol diacrylate, 1,6-hexanediol diacrylate (e.g., SR238B from Sartomer), alkoxylated hexanediol diacrylate, alkoxylated neopentyl glycol diacrylate, cyclohexane dimethanol diacrylate, diethylene glycol diacrylate (e.g., SR230 from Sartomer), ethoxylated bisphenol A diacrylate (such as ethoxylated (4) bisphenol A diacrylate, e.g., SR601 from Sartomer), neopentyl glycol diacrylate, polyethylene glycol diacrylate (such as polyethylene glycol (400) diacrylate, e.g., SR344 from Sartomer), propoxylated neopentyl glycol diacrylate (such as propoxylated (2) neopentyl glycol diacrylate, e.g., SR9003B from Sartomer), tetraethylene glycol diacrylate (e.g., SR268 from Sartomer), tricyclodecane dimethanol diacrylate (e.g., SR833S from Sartomer), triethylene glycol diacrylate (e.g., SR272 from Sartomer), and tripropylene glycol diacrylate.

Suitable, illustrative trifunctional (meth)acrylates include ethoxylated

trimethylolpropane triacrylate (such as ethoxylated (9) trimethylolpropane triacrylate), pentaerythritol triacrylate, propoxylated glyceryl triacrylate (such as propoxylated (3) glyceryl triacrylate, e.g., SR9020 from Sartomer), propoxylated trimethylolpropane triacrylate (such as propoxylated (3) trimethylolpropane triacrylate, e.g., SR492 from Sartomer), tris(2-hydroxylethyl) isocyanurate triacrylate (e.g., SR368 from Sartomer), and ethoxylated trimethylolpropane triacrylate (such as ethoxylated (3) trimethylolpropane triacrylate, e.g., SR454 from Sartomer).

In a preferred embodiment, the at least one functional (meth)acrylate monomer comprises at least one sterically-hindered mono(meth)acrylate monomer.

A sterically-hindered mono(meth)acrylate monomer may comprise a cyclic moiety and/or a tert-butyl group. The cyclic moiety may be monocyclic, bicyclic or tricyclic, including bridged, fused and/or spirocyclic ring systems. The cyclic moiety may be carbocyclic (all of the ring atoms are carbons), or heterocyclic (at least one the rings atoms is a heteroatom such as N, O or S). The cyclic moiety may be aliphatic, aromatic or a combination of aliphatic and aromatic. In particular, the cyclic moiety may comprise a ring or ring system selected from cycloalkyl, heterocycloalkyl, aryl, heteroaryl and combinations thereof. More particularly, the cyclic moiety may comprise a ring or ring system selected from phenyl, cyclopentyl, cyclohexyl, norbornyl, tricyclodecanyl, dicyclopentadienyl, oxiranyl, oxetanyl, tetrahydrofuranyl, tetrahydropyranyl, dioxolanyl, dioxanyl, dioxaspirodecanyl and dioxaspiroundecanyl. The ring or ring system may be optionally substituted by one or more groups selected from hydroxyl, alkoxy, alkyl, hydroxyalkyl, cycloalkyl, aryl, alkylaryl and arylalkyl.

In particular, the cyclic moiety may correspond to one of the following formulae:

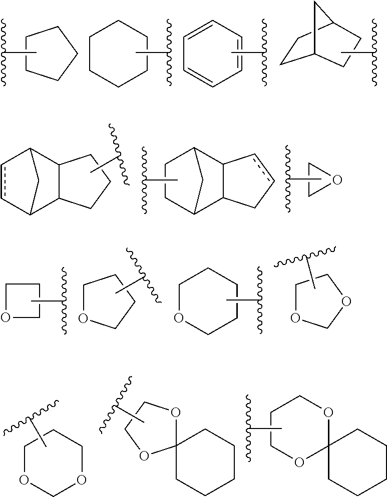

wherein
the symbol [symbol] represents the point of attachment to a moiety comprising a (meth)acrylate functional group,
the hashed bond [symbol] represents a single bond or a double bond;
and each ring atom may be optionally substituted by one or more groups selected from hydroxyl, alkoxy, alkyl, hydroxyalkyl, cycloalkyl, aryl, alkylaryl and arylalkyl.

In particular, the sterically hindered mono(meth)acrylate monomer comprises a cyclic moiety, such as a moiety comprising an aliphatic ring, in particular an aliphatic ring selected from cyclohexane, tricyclodecane, tetrahydrofuran, bornane, 1,3-dioxolane and 1,3-dioxane.

Examples of sterically hindered mono(meth)acrylate monomers are tert-butyl (meth)acrylate, 2-phenoxyethyl (meth)acrylate, benzyl (meth)acrylate, isobornyl (meth)acrylate, tert-butyl cyclohexyl (meth)acrylate, 3,3,5-trimethyl cyclohexyl (meth)acrylate, dicyclopentadienyl (meth)acrylate, tricyclodecane methanol mono(meth)acrylate, tetrahydrofurfuryl (meth)acrylate, cyclic trimethylolpropane formyl (meth)acrylate (CTFA, also referred to as 5-ethyl-1,3-dioxan-5-yl)methyl (meth)acrylate), (2,2-dimethyl-1,3-dioxolan-4-yl)methyl (meth)acrylate, (2-ethyl-2-methyl-1,3-dioxolan-4-yl)methyl (meth)acrylate, glycerol formal methacrylate, the alkoxylated (i.e. ethoxylated and/or propoxylated) derivatives thereof and mixtures thereof.

In particular, the at least one functional (meth)acrylate monomer comprises a sterically hindered mono(meth)acrylate monomer selected from isobornyl acrylate, cyclic trimethylolpropane formal acrylate and mixtures thereof.

The sterically-hindered mono(meth)acrylate monomer may represent at least 10%, from 10 to 70%, from 15 to 65%, from 20 to 60%, from 25 to 55% or from 30 to 50%, by weight of the total weight of the curable composition.

In a preferred embodiment, the at least one functional (meth)acrylate monomer comprises at least one acyclic mono(meth)acrylate monomer.

The acyclic mono(meth)acrylate monomer may be linear or branched, preferably linear.

Examples of acyclic mono(meth)acrylate monomers are octyldecyl (meth)acrylate, 2-ethylhexyl (meth)acrylate, isooctyl (meth)acrylate, dodecyl (meth)acrylate, lauryl (meth)acrylate, ethoxyethoxy ethyl (meth)acrylate, as well as the alkoxylated (i.e. ethoxylated and/or propoxylated) derivatives thereof and mixtures thereof.

The acyclic mono(meth)acrylate monomer may represent at least 5%, from 5 to 60%, from 8 to 55%, from 10 to 50%, from 15 to 45% or from 20 to 40%, by weight of the total weight of the curable composition.

In a particularly preferred embodiment, the functional (meth)acrylate monomer comprises at least two functional (meth)acrylate monomers; in particular the functional (meth)acrylate monomer comprises:
at least one sterically hindered mono(meth)acrylate monomer, such as isobornyl (meth)acrylate, cyclic trimethylolpropane formal acrylate and mixtures thereof; and
at least one acyclic mono(meth)acrylate monomer, such as octyldecyl (meth)acrylate, 2-ethylhexyl (meth)acrylate, isooctyl (meth)acrylate, dodecyl (meth)acrylate, lauryl (meth)acrylate, ethoxyethoxy ethyl (meth)acrylate, as well as the alkoxylated (i.e. ethoxylated and/or propoxylated) derivatives thereof and mixtures thereof.

The sterically-hindered mono(meth)acrylate monomer may represent from 30 to 90%, from 35 to 85%, from 40 to 80%, from 45 to 75%, from 50 to 70%, by weight of the total weight of the functional (meth)acrylate monomers.

The acyclic mono(meth)acrylate monomer may represent at least 10 to 70%, from 15 to 65%, from 20 to 60%, from 25 to 55%, from 30 to 50%, by weight of the total weight of the functional (meth)acrylate monomers.

Preferred (meth)acylate monomers are the monofunctional SR531 cyclic formal acrylate, cyclic trimethylolpropane formal acrylate (a cycloaliphatic acrylate) and SR256, ethoxyethoxyethyl acrylate (a linear aliphatic acrylate) from Sartomer.

The mono(meth)acrylate functional monomers may include a moderate-Tg mono(meth)acrylate having a first glass transition temperature and a low-Tg mono(meth)acrylate having a second glass transition temperature less than the first glass transition temperature. In such embodiments, the first glass transition temperature may range from greater than 30° C. to about 175° C., such as from about 50° C. to about 175° C., from about 50° C. to about 150° C. or from about 75° C. to about 130° C., from greater than 30° C. to about 70° C., from about 50° C. to about 70° C., or from about 90° C. to about 120° C., or from about 100° C. to about 120° C., or from about 110° C. to about 115° C. Also, in such embodiments, the second glass transition temperature may range from about −50° C. to about 30° C., such as from about −50° C. to about 10° C., from about −40° C. to about 0° C., from about −30° C. to about 0° C., or about −30° C. to about −10° C. Except where noted otherwise to the contrary, the glass transition temperatures referred to herein are glass transition temperatures measured by differential scanning calorimetry using techniques known in the art.

Examples of low-Tg monofunctional (meth)acrylate monomer include cyclic trimethylolpropane formal acrylate, butyl (meth)acrylate, octyl (meth)acrylate, 2-ethylhexyl (meth)acrylate, isooctyl (meth)acrylate, decyl-(meth)acrylate, isodecyl (meth)acrylate, ethoxylated tetrahydrofuryl (meth)acrylate, tert-butyl (meth)acrylate, and tert-butyl methacrylate.

Examples of moderate-Tg monofunctional (meth)acrylate monomer may include monofunctional (meth)acrylate bearing at least one cycloaliphatic group such as isobornyl (meth)acrylate, for example.

In one embodiment, two functional (meth)acrylates are employed wherein one comprises a cycloaliphatic group and the other comprises a linear aliphatic group.

The at least one functional (meth)acrylate monomer can be selected in view of the final desired properties. For example, low Tg adhesive monomers such as octyldecyl acrylate, 2-ethylhexyl acrylate, isooctyl acrylate, dodecyl acrylate, lauryl (meth)acrylate, propoxylated THF acrylate, THF acrylate, and ethoxyethoxy ethyl acrylate may be selected. For higher Tg materials, isobornyl (meth)acrylate, isophoryl (meth)acrylate, tertbutyl cyclohexyl (meth)acrylate and cyclic trimethylolpropane formal acrylate may be selected. Higher functionality compounds such as hexane diol diacrylate, triethylene glycol diacrylate, dipropylene glycol diacrylate, dodecane diol diacrylate, and tricyclododecane dimethanol diacrylate can also be employed. Isobornyl acrylate and cyclic trimethylolpropane formal acrylate are most preferred.

The at least one functional (meth)acrylate component may be present in the curable composition disclosed herein at from about 10 to about 90 wt. %, preferably from about 20 to about 80 wt. %, and most preferably from about 25 to about 60 wt. %, based on the weight of the curable composition. The total amount of functional (meth)acrylate monomers in the curable pressure sensitive adhesive composition may be from 30 to 90%, from 35 to 85%, from 40 to 80% or from 45 to 75%, by weight based on the weight of the curable composition.

The curable composition disclosed herein comprises at least one photo-initiator. The photo-initiator is not particularly limited as long as it can initiate photopolymerization when exposed to actinic radiation. Examples thereof that can be used include benzoin ether-based photopolymerization initiator, acetophenone-based photopolymerization initiator, a-ketol-based photopolymerization initiator, aromatic sulfonyl chloride-based photopolymerization initiator, photoactive oxime-based photopolymerization initiator, benzoin-based photopolymerization initiator, benzyl-based photopolymerization initiator, benzophenone-based photopolymerization initiator, ketal-based photopolymerization initiator, thioxanthone-based photopolymerization initiator, acylphosphine oxide-based photopolymerization initiator, and the like.

Specific examples of the benzoin ether-based photo-initiator include benzoin methyl ether, benzoin ethyl ether, benzoin propyl ether, benzoin isopropyl ether, benzoin isobutyl ether, 2,2-dimethoxy-1,2-diphenylethan-1-one (trade name: IRGACURE 651, manufactured by BASF), anisoin methyl ether, and the like. Examples of the acetophenone-based photopolymerization initiator include 1-hydroxycyclohexyl phenyl ketone (trade name: IRGACURE 184, manufactured by BASF), 4-phenoxydichloroacetophenone, 4-t-butyl-dichloroacetophenone, 1-[4-(2-hydroxyethoxy)-phenyl]-2-hydroxy-2-methyl-1-propan-1-one (trade name: IRGACURE 2959, manufactured by BASF), 2-hydroxy-2-methyl-1-phenyl-propan-1-one (trade name: DAROCUR 1173, manufactured by BASF), methoxyacetophenone, and the like.

Examples of the α-ketol-based photo-initiator include 2-methyl-2-hydroxypropiophenone, 1-[4-(2-hydroxyethyl)-phenyl]-2-hydroxy-2-methylpropan-1-one, and the like.

Examples of the aromatic sulfonyl chloride-based photo-initiator include 2-naphthalene sulfonyl chloride and the like.

Examples of the photoactive oxime-based photo-initiator include 1-phenyl-1,2-propanedione-2-(O-ethoxycarbonyl)-oxime, and the like.

Examples of the benzoin-based photo-initiator include benzoin and the like. Examples of the benzyl-based photo-initiator include benzyl and the like.

Examples of the benzophenone-based photo-initiators include benzophenone, benzoylbenzoic acid, 3,3′-dimethyl-4-methoxybenzophenone, polyvinyl benzophenone, a-hydroxycyclohexyl phenyl ketone, and the like.

Examples of the ketal-based photo-initiator include benzyl dimethyl ketal and the like.

Examples of the thioxanthone-based photo-initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone and the like.

Examples of the acylphosphine oxide-based photo-initiator include bis(2,6-

dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1- methylpropan-1-yl)phosphine oxide, bis(2,6-diethoxybenzoyl)(2-methylpropan-1-yl)phosphine oxide, bis(2,6-diethoxybenzoyl) (1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, and the like.

In certain embodiments, the photo-initiator is selected from the group consisting of diphenyl(2,4,6-trimethylbenzoyl)phosphine oxide, benetex mayzo OB+, 2,2′-(2,5-thiophenediyl)bis(5-tert-butylbenzoxazole), bromothymol blue, and 3′,3″-Dibromothymolsulfonphthalein.

In some embodiments, the photo-initiator generates free radicals under light exposure by one of intramolecular bond cleavage or intermolecular hydrogen abstraction. Typically, the monomer will polymerize when exposed to UV light (wavelengths of 10 nm to 400 nm), although photo-initiators are typically used to initiate polymerization when exposed to other wavelengths, such as in the visible spectrum. In certain embodiments, light exposure is produced from light having one or more wavelengths selected from about 200 nm to about 700 nm, such as about 250, 300, 350, 400, 500, or 600 nm.

A photoinitiator may generally be present in a total concentration of up to about 15% by weight based on the total weight of the curable composition. In certain embodiments, the photoinitiator is present in a concentration of from about 0.01 to about 5 parts by weight, from about 0.05 to about 3 parts by weight, about 0.05 to about 1.5 parts by weight, and about 0.1 to about 1 part by weight, based on 100 parts by total weight of the curable composition described above.

In preferred embodiments, the curable composition disclosed herein is free of solvents.

The curable composition disclosed herein optionally comprises at least one isocyanate-reactive chain extender compound, which functions to increase the molecular weight of the final adhesive. As understood by one of ordinary skill in the art, a chain extender includes at least one active hydrogen. Those of ordinary skill in the polyurethane chemistry art will understand that a wide variety of materials are suitable for this component. For example, amines, thiols, and polyols may be used as chain extenders.

Preferably, the chain extender includes a hydroxy-functional compound. Polyols are the preferred hydroxy-functional material used in the present invention. Polyols can be of any molecular weight, however, relatively low molecular weight polyols (i.e., having a weight average molecular weight of less than about 250) are preferred. Polyols provide urethane linkages when reacted with an isocyanate-group containing compounds, such as a polyisocyanate.

Polyols, as opposed to monols, have at least two hydroxy-functional groups. Generally and preferably, diols are used in the present disclosure. Diols contribute to formation of relatively high molecular weight polymers without requiring crosslinking, such as is conventionally introduced by polyols having greater than two hydroxy-functional groups. PSAs prepared from such diols generally have increased shear strength, peel adhesion, and/or a balance thereof, to provide PSA properties that may be desired for certain applications.

Examples of polyols useful in the present invention include, but are not limited to, polyester polyols (e.g., lactone polyols) and the alkylene oxide (e.g., ethylene oxide; 1,2-epoxypropane; 1,2-epoxybutane; 2,3-epoxybutane; isobutylene oxide; and epichlorohydrin) adducts thereof, polyether polyols (e.g., polyoxyalkylene polyols, such as polypropylene oxide polyols, polyethylene oxide polyols, polypropylene oxide polyethylene oxide copolymer polyols, and polyoxytetramethylene polyols; polyoxycycloalkylene polyols; polythioethers; and alkylene oxide adducts thereof), polyalkylene polyols, mixtures thereof, and copolymers therefrom. Polyoxyalkylene polyols are preferred.

In general, preferred diols useful in the present invention can be represented by Formula III:

[Chem 15]

HO—Y—OH Formula III

wherein Y represents an aliphatic group, alkyl group, aromatic group, mixtures thereof, polymers thereof, or copolymers thereof.

Although polyols containing more than two hydroxy-functional groups are generally less preferred than diols, certain higher functional polyols may also be used in the present invention. These higher functional polyols may be used alone, or in combination with other chain extenders.

For broader formulation latitude, at least two chain extenders, such as polyols, may be used. It has been found that using at least one material having a relatively low weight average molecular weight in combination with at least one material having a relatively high weight average molecular weight results in PSAs having significantly greater shear strength (i.e., holding power), but comparable, or still adequate, peel adhesion, as compared to those PSAs derived from a single chain extender. Thus, this aspect of the present disclosure provides PSAs that can be used in applications where higher holding power is desired, but ease of removability from the adherend is also desired. However, the ratio and types of materials in the isocyanate-reactive component mixture can be adjusted to obtain a wide range of shear strengths and peel adhesions in PSAs prepared therefrom.

The curable composition disclosed herein may also include additional components including, but not limited to, fillers, plasticizers, and tackifying resins. It is preferred that the various components of the curable pressure sensitive adhesive composition of the present invention are selected, such that they are compatible with each other and do not phase separate.

For example, a plasticizer that increases the softness and flexibility of the cured material may be incorporated in various embodiments of the present invention. Plasticizers are well known and typically do not participate in polymerization of (meth)acrylate groups. One or more plasticizers may be selected from the group consisting of vegetable oil, mineral oil, soybean oil, terpine resins, unsubstituted or carboxy-substituted polyisoprene, polybutadiene, or polybutylene resins, xylene polymer, hydroxyl-terminated polybutadiene or polyolefins, and hydrogenated diene or polybutadiene resins, such as butadiene resins. If present, the curable pressure sensitive adhesive composition according to the present invention may include 20-50 wt. %, more preferably 25-45 wt. %, and most preferably 30-40 wt. % of plasticizer, based on the total weight of the curable pressure sensitive adhesive composition.

Any common tackifiers typically used in a pressure sensitive adhesive composition that are known by those having skill in the art may be used in the curable pressure sensitive adhesive composition according to the present invention. An example of a tackifier is hydrogenated terpene resin, such as hydrogenated cyclohexene, 1-methyl-4-(1-methylenthenyl)-homopolymer sold under the trade name Clearon P85 by Yasuhara Chemical Co. Ltd. Other optional components of the curable pressure sensitive adhesive composition according to the present invention include, but are not limited to, silicone-based adhesives for additional curable materials, metal oxide particles for modifying the refractive index of the cured material, and rheology modifiers. The curable composition and adhesive layer can optionally include one or more additives such as antioxidants, stabilizers, fire retardants, viscosity modifying agents, antifoaming agents, antistatic agents and wetting agents.

Generally, the components described above can be directly combined with each other to form a curable composition, including crosslinkers, photo-initiators, etc., in amounts as useful and as described herein. While solventless embodiments are visualized within the scope of this invention, it is contemplated that solvents can be used to prepare embodiments of the curable compositions. Representative solvents can be organic, and include acetone, methyl-ethyl-ketone, ethyl acetate, heptane, toluene, cyclopentanone, methyl cellosolve acetate, methylene chloride, nitromethane, methyl formate, gamma-butyrolactone, propylene carbonate, and 1,2-dimethoxyethane (glyme).

### Pressure Sensitive Adhesive

The components, when blended, provide an adhesive that can be applied as a pressure sensitive adhesive film or tape. The curable pressure sensitive adhesive composition according to the invention may be cured with any actinic or other radiation to provide a pressure sensitive adhesive . Thus, in another embodiment, there is provided a pressure sensitive adhesive comprising a polymeric reaction product of a curable pressure sensitive adhesive composition as detailed above.

The pressure sensitive adhesive disclosed herein has significantly elevated shear failure temperatures. In some embodiments, the pressure sensitive adhesive has shear failure temperature of at least about 204° C., at least about 210° C., at least about 215° C., at least about 221° C., at least about 227° C., at least about 232° C., at least about 238° C., at least about 243° C., at least about 249° C., and/or at least about 254° C. The shear adhesive failure temperature was determined in accordance with ASTM D4498.

The pressure sensitive adhesive disclosed herein has acceptable peel and tack properties. In the examples below, peel performance was determined in accordance with ASTM D903-98(2017). Tack performance was determined in accordance with ASTM 2979-01.

### Methods

The invention further relates to methods of using the curable PSA adhesives. In yet another embodiment, there is provided herein a method of applying a pressure sensitive adhesive to a substrate is disclosed. The method comprises the steps of: (i) applying a curable pressure sensitive adhesive composition as detailed above to a surface of a substrate; and (ii) exposing the curable composition to actinic radiation to polymerize at least a portion of the composition to generate the pressure sensitive adhesive.

The curable pressure sensitive adhesive composition may be applied by any conventional application method, including but not limited to gravure coating, curtain coating, slot coating, spin coating, screen coating, transfer coating, brush or roller coating, and the like. The thickness of a coated adhesive layer, (sometimes provided in liquid form), prior to curing, can be any thickness that results in the desired properties, as is well understood in the art. Exemplary thicknesses of an uncured, curable adhesive layer may be in the range from about 0.05 to about 125 micrometers.

The amount of cure time to harden or cure the adhesive can vary, depending on a variety of factors, such as the components present in the curable pressure sensitive adhesive composition, the substrates used, as well as the thickness of the applied layer. Use of a UV irradiation (actinic) source can significantly lower the cure time necessary to cure adhesives of the invention, compared to, for example, thermal (heat) curing techniques. Thus, practicing a method according to the invention can provide faster manufacturing processes, and can lead to decreased operating costs.

In an aspect, a curable pressure sensitive adhesive composition can be applied onto a surface of a substrate, contacting the curable adhesive with another material, and then curing the adhesive composition. Lamination can be used to contact the two materials, having the adhesive therebetween. Optionally, methods can also include applying the adhesive onto a release liner; drying any solvent in the adhesive; laminating; polymerizing or curing the acrylate oligomers and optionally acrylate copolymers; and any other steps, techniques, or methods known to be used in the preparation of multi-layer articles.

If a photoinitiator is used, irradiation sources that provide energy (e.g., light) in the region from 200 to 800 nm can be used to cure embodiments of the adhesive composition. In an aspect, a useful region of light is about 250 to about 700 nm. Suitable sources of radiation to initiate actinic curing include mercury vapor discharge lamps, carbon arcs, quartz halogen lamps, tungsten lamps, xenon lamps, fluorescent lamps, lasers, sunlight, etc. The amount of radiation exposure to effect polymerization can depend on factors such as the identity and concentrations of particular free radically polymerizable oligomers, the thickness of the exposed material, the type of substrate(s), the intensity of the radiation source and the amount of heat associated with the radiation. Alternatively, other sources of energy such as electron beam and gamma ray can be used for curing the adhesive, with or without an added initiator.

### ASPECTS OF THE INVENTION

The invention may be according to the following aspects:

Aspect 1. A curable pressure sensitive adhesive composition, the curable composition comprising:
a. a pre-polymer having a structure according to Formula I:

[Chem 16]

R₁—[Polymer]—R₂ Formula I,
wherein the [Polymer] is a linear or branched polymer backbone derived from the reaction of farnesene and at least one other monomer; and
R₁ is a (C₁-C₁₂) alkyl group or R₂, and R₂ comprises a (meth)acrylate group having a structure according to Formula II

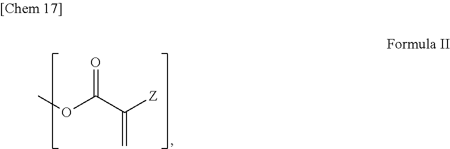

wherein Z is selected from the group consisting of hydrogen and methyl;
b. at least one functional (meth)acrylate monomer; and
c. at least one photo-initiator.

Aspect 2. The curable composition of aspect 1, wherein the photo-initiator is present in an amount of from about 0.1 wt % to 5 wt %, based on the total weight of the composition.

Aspect 3. The curable composition of aspect 1 or 2, wherein the [Polymer] component of the pre-polymer of Formula I is derived from the reaction of β-farnesene and at least one other monomer selected from a diene, an oxygen source, a diisocyanate and mixtures thereof, in particular, the [Polymer] component of the pre-polymer of Formula I is derived from the reaction of β-farnesene, an oxygen source, a diisocyanate and optionally a diene.

Aspect 4. The curable composition of any one of aspects 1 to 3, wherein the [Polymer] component of the pre-polymer of Formula I may correspond to one of the following formulae:

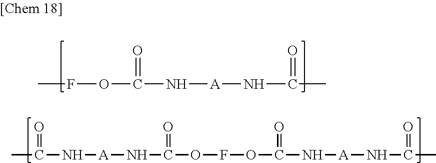

wherein
A is the residue of a diisocyanate without the NCO groups;
F is a polymeric moiety comprising repeating units derived from farnesene and optionally a diene.

Aspect 5. The curable composition of any one of aspects 1 to 4, wherein R₂ is a group of formula III

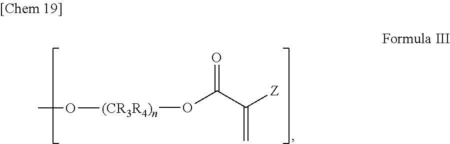

wherein Z is selected from the group consisting of hydrogen and methyl;
R₃ and R₄ are independently selected from the group consisting of hydrogen and methyl;
n is 2 to 10.

Aspect 6. The curable composition of any one of aspects 1 to 4, wherein R₂ is a group of formula IV

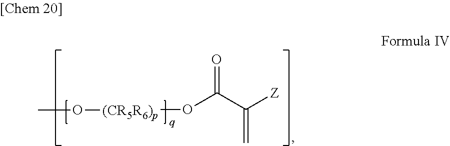

wherein Z is selected from the group consisting of hydrogen and methyl;
R₅ and R₆ are independently selected from the group consisting of hydrogen and methyl;
p is 2 to 4, in particular 2;
q is 2 to 30.

Aspect 7. The curable composition of any one of aspects 1 to 6, wherein R₁=R₂. Aspect 8. The curable composition of any one of aspects 1 to 7, wherein the pre-polymer of Formula I corresponds to the following formula V:

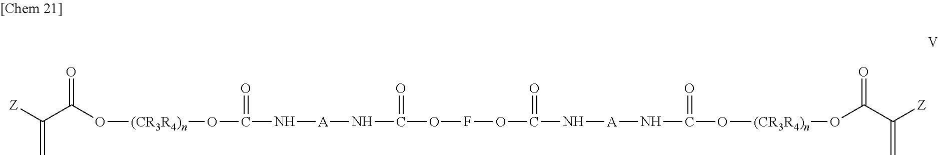

wherein
A is the residue of a diisocyanate without the NCO groups, preferably the residue of isophorone diisocyanate;
F is a polymeric moiety comprising repeating units obtained by the polymerization of farnesene and optionally a diene;
Z is selected from the group consisting of hydrogen and methyl, preferably H;
R₃ and R₄ are independently selected from the group consisting of hydrogen and methyl, preferably H;
n is 2 to 10, preferably 2.

Aspect 9. The curable composition of any one of aspects 1 to 4, wherein R₁ is methyl.

Aspect 10. The curable composition of any one of aspects 1 to 9, wherein Z is methyl.

Aspect 11. The curable composition of any one of aspects 1 to 9, wherein Z is hydrogen.

Aspect 12. The curable composition of any one of aspects 1 to 11, wherein the at least one functional (meth)acrylate monomer comprises at least one linear aliphatic acrylate monomer and at least one cycloaliphatic acrylate monomer.

Aspect 13. The curable composition of any one of aspects 1 to 12, wherein the at least one functional (meth)acrylate monomer comprises at least one monomer selected from the group consisting of 2-phenoxyethylacrylate, alkoxylated lauryl acrylate, alkoxylated phenol acrylate, alkoxylated tetrahydrofurfuryl acrylate, caprolactone acrylate, cyclic trimethylolpropane formyl acrylate, ethylene glycol methyl ether methacrylate, ethoxylated nonyl phenol acrylate, isobornyl acrylate, isobornyl methacrylate, isodecyl acrylate, 2-ethylhexyl acrylate, isooctyl acrylate, lauryl acrylate, octadecyl acrylate, tetrahydrofurfuryl acrylate, tridecyl acrylate, and 4-acryolyl morpholine.

Aspect 14. A pressure sensitive adhesive comprising a polymeric reaction product of a curable pressure sensitive adhesive composition as defined in any one of claims 1 to 13, wherein the pressure sensitive adhesive has a shear failure temperature greater than about 204° C.

Aspect 15. A method of applying a pressure sensitive adhesive to a substrate, the method comprises the steps of:
(i) applying a curable pressure sensitive adhesive composition as defined in any one of aspects 1 to 13 to a substrate; and
(ii) exposing the curable composition to actinic radiation to polymerize at least a portion of the composition to generate the pressure sensitive adhesive.

The methods and compositions disclosed herein will be illustrated in more detail with reference to the following Examples, but it should be understood that it is not deemed to be limited thereto.

### EXAMPLES

Evaluation of NTX-13882 comprising:
90 wt % of urethane acrylate oligomer, obtained by reaction of hydroxyethyl acrylate, isophorone diisocyanate and a polyfarnesene diol; and
10 wt % of SR506, which is isobornyl acrylate (cycloaliphatic acrylate), based on the total weight of NTX-13882.

A blend was prepared with 28.5 wt % of NTX-13882, 38 wt % SR 531 (a cycloaliphatic acrylate), 28.5 wt % of SR 256 (a linear aliphatic acrylate) and 5 wt % of diphenyl(2,4,6-trimethylbenzoyl)phosphine oxide (photoinitiator) based on the total weight of the composition. The blend was applied to a surface of a substrate, and irradiated with a medium pressure mercury arc lamp at 0.49 J/cm² to produce a film that yielded a shear failure temperature of 255° C., with a stainless steel peel of 3.11 N and a tack of 0.017 kg/cm².

Although illustrated and described above with reference to certain specific embodiments and examples, embodiments disclosed herein are nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

1. A curable pressure sensitive adhesive composition, the curable composition comprising:
a. a pre-polymer having a structure according to Formula I:
R₁—[Polymer]—R₂ Formula I,
wherein the [Polymer] is a linear or branched polymer backbone derived from the reaction of farnesene and at least one other monomer; and
R₁ is a (C₁-C₁₂) alkyl group or R₂, and R₂ comprises a (meth)acrylate group having a structure according to Formula II 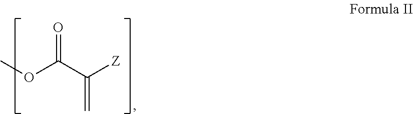
wherein Z is selected from the group consisting of hydrogen and methyl;
b. at least one functional (meth)acrylate monomer; and
c. at least one photo-initiator.

2. (canceled)

3. The curable composition of claim 1, wherein the [Polymer] component of the pre-polymer of Formula I is derived from the reaction of β-farnesene and at least one other monomer selected from a diene, an oxygen source, a diisocyanate and mixtures thereof.

4. The curable composition of claim 1, wherein the [Polymer] component of the pre-polymer of Formula I corresponds to one of the following formulae: 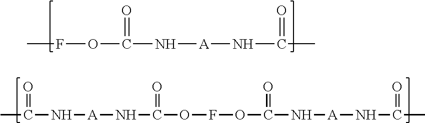
wherein
A is the residue of a diisocyanate without the NCO groups;
F is a polymeric moiety comprising repeating units derived from farnesene and optionally a diene.

5. The curable composition of claim 1, wherein R₂ is a group of formula III: 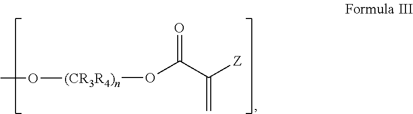
wherein Z is selected from the group consisting of hydrogen and methyl;
R₃ and R₄ are independently selected from the group consisting of hydrogen and methyl;
n is 2 to 10.

6. The curable composition of claim 1, wherein R₂ is a group of formula IV 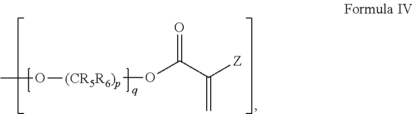
wherein Z is selected from the group consisting of hydrogen and methyl;
R₅ and R₆ are independently selected from the group consisting of hydrogen and methyl;
p is 2 to 4; and
q is 2 to 30.

7. The curable composition of claim 1, wherein R₁=R₂.

8. The curable composition of claim 1, wherein the pre-polymer of Formula I corresponds to the following formula V: 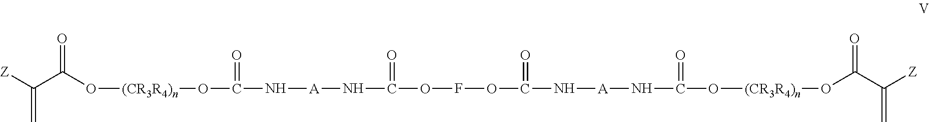
wherein
A is the residue of a diisocyanate without the NCO groups;
F is a polymeric moiety comprising repeating units obtained by the polymerization of farnesene and optionally a diene;
Z is selected from the group consisting of hydrogen and methyl
R₃ and R₄ are independently selected from the group consisting of hydrogen and methyl; and
n is 2 to 10.

9. The curable composition of claim 1, wherein R₁ is methyl.

10. The curable composition of claim 1, wherein Z is methyl.

11. The curable composition of claim 1, wherein Z is hydrogen.

12. The curable composition of claim 1, wherein the total amount of pre-polymer of Formula I in the curable composition is from 10 to 70%, from 15 to 65%, from 20 to 60% or from 25 to 55%, by weight based on the weight of the curable composition.

13. The curable composition of claim 1, wherein the at least one functional (meth)acrylate monomer comprises at least one sterically hindered mono(meth)acrylate monomer.

14. (canceled)

15. The curable composition of claim 13, wherein the at least one sterically hindered mono(meth)acrylate monomer is selected from isobornyl (meth)acrylate, cyclic trimethylolpropane formal acrylate and mixtures thereof.

16. (canceled)

17. The curable composition of claim 1, wherein the at least one functional (meth)acrylate monomer comprises at least one acyclic mono(meth)acrylate monomer.

18. (canceled)

19. The curable composition of claim 17, wherein the at least one acyclic mono(meth)acrylate monomer is ethoxyethoxy ethyl (meth)acrylate.

20. (canceled)

21. The curable composition of 1, wherein the at least one functional (meth)acrylate monomer comprises
at least one sterically hindered mono(meth)acrylate monomer; and
at least one acyclic mono(meth)acrylate monomer.

22. (canceled)

23. (canceled)

24. (canceled)

25. The curable composition of claim 1, wherein the at least one functional (meth)acrylate monomer comprises at least one linear aliphatic acrylate monomer and at least one cycloaliphatic acrylate monomer.

26. The curable composition of claim 1, wherein the at least one functional (meth)acrylate monomer comprises at least one selected from the group consisting of 2-phenoxyethylacrylate, alkoxylated lauryl acrylate, alkoxylated phenol acrylate, alkoxylated tetrahydrofurfuryl acrylate, caprolactone acrylate, cyclic trimethylolpropane formyl acrylate, ethylene glycol methyl ether methacrylate, ethoxylated nonyl phenol acrylate, isobornyl acrylate, isobornyl methacrylate, isodecyl acrylate, 2-ethylhexyl acrylate, isooctyl acrylate, lauryl acrylate, octadecyl acrylate, tetrahydrofurfuryl acrylate, tridecyl acrylate, and 4-acryolyl morpholine.

27. A pressure sensitive adhesive comprising a polymeric reaction product of a curable pressure sensitive adhesive composition as defined in claim 1,wherein the pressure sensitive adhesive has a shear failure temperature greater than about 204° C.

28. A method of applying a pressure sensitive adhesive to a substrate, the method comprising the steps of:
(i) applying a curable pressure sensitive adhesive composition as defined in claims 1 to a substrate;
(ii) exposing the curable composition to actinic radiation to polymerize at least a portion of the composition to generate the pressure sensitive adhesive.
